(19) United States
(12) Patent Application Publication
(10) Pub. No.: US 2013/0186472 A1
(43) Pub. Date: Jul. 25, 2013

(54) ELECTRONIC LOAD DROP PROTECTION FOR HYDRAULIC FLUID SYSTEM

(71) Applicant: EATON CORPORATION, Cleveland, OH (US)

(72) Inventor: Christopher William Schottler, Chanhassen, MN (US)

(73) Assignee: EATON CORPORATION, Cleveland, OH (US)

(21) Appl. No.: 13/740,562

(22) Filed: Jan. 14, 2013

Related U.S. Application Data
(60) Provisional application No. 61/588,919, filed on Jan. 20, 2012.

(51) Int. Cl. F17D 3/00

(52) U.S. Cl. CPC F17D 3/00
USPC 137/12; 137/565.13

(57) ABSTRACT

A method of controlling a valve includes detecting a supply pressure at a fluid source and detecting a first port pressure at a first side of a piston. A controller actuates the valve from a closed position to a first open position when the supply pressure is in excess of the first port pressure. Thereafter, the controller actuates the valve to the closed position when the supply pressure is less than the first port pressure.

### CROSS-REFERENCE TO RELATED APPLICATIONS

This application claims priority to and the benefit of U.S. Provisional Patent Application Ser. No. 61/588,919, filed Jan. 20, 2012, entitled “Electronic Load Drop Protection for Hydraulic Fluid System,” the disclosure of which is hereby incorporated by reference herein in its entirety.

### INTRODUCTION

Traditionally, hydraulic control systems use a mechanical check valve to ensure that a load that resists gravity does not move in the opposite direction of a command velocity. In this way, the check valve ensures that a supply pressure from a pump is higher than the port pressure on an associated actuator or cylinder. One such hydraulic control system 100 is depicted in FIG. 1. The system 100 includes a pump 102 that draws hydraulic fluid from a fluid reservoir 104. The pump discharge is forced upwards against the force of gravity G. A two-way valve 106 includes a first open position 106a, a second open position 106b, and a closed position 106c. When the valve 106 is in the first position 106a, flow from the pump 102 is delivered to a first port 108 of a piston cylinder 110. When the valve 106 is in the second position 106b, flow from the pump 102 is delivered to a second port 112 of the piston cylinder 110. As fluid is delivered to one of the two ports 108, 112, the piston 114 moves within the cylinder 110, and hydraulic fluid is forced out of the opposite of the two ports 112, 108. When the valve 106 is in the closed position 106c, flow into and out of the piston cylinder 110 is prevented.

A check valve 116 is positioned between the outlet of the pump 102 and the valve 106. When the valve 106 is in the first position 106a, the check valve 116 prevents excessive head pressure from the fluid in the piston cylinder 110 from being forced back against the output flow of the pump 102. While check valves are often used in systems that pump fluid against the force of gravity, they are subject to fouling or damage that may prevent proper operation.

### SUMMARY

In one aspect, the technology relates to a method of controlling a valve, the method including: detecting a supply pressure at a fluid source; detecting a first port pressure at a first side of a piston, the piston located in a cylinder; actuating the valve from a closed position to a first open position when the supply pressure is in excess of the first port pressure; and actuating the valve to the closed position when the supply pressure is less than the first port pressure.

In another aspect, the technology relates to a hydraulic control system including: a piston cylinder; a pump connected to a source of hydraulic fluid; a valve located between the piston cylinder and the pump; a supply pressure sensor located on a fluid line at an outlet of the pump; a first port pressure sensor located on a fluid line at a first inlet of the piston cylinder; and a controller operatively connected to the valve, the supply pressure sensor, and the first port pressure sensor, wherein the controller sends a first signal to actuate the valve from a closed position to a first open position upon detecting a supply pressure higher than a first port pressure, and wherein the controller actuates the valve to the closed position when the supply pressure is less than the first port pressure.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a schematic diagram of a prior art hydraulic control system.

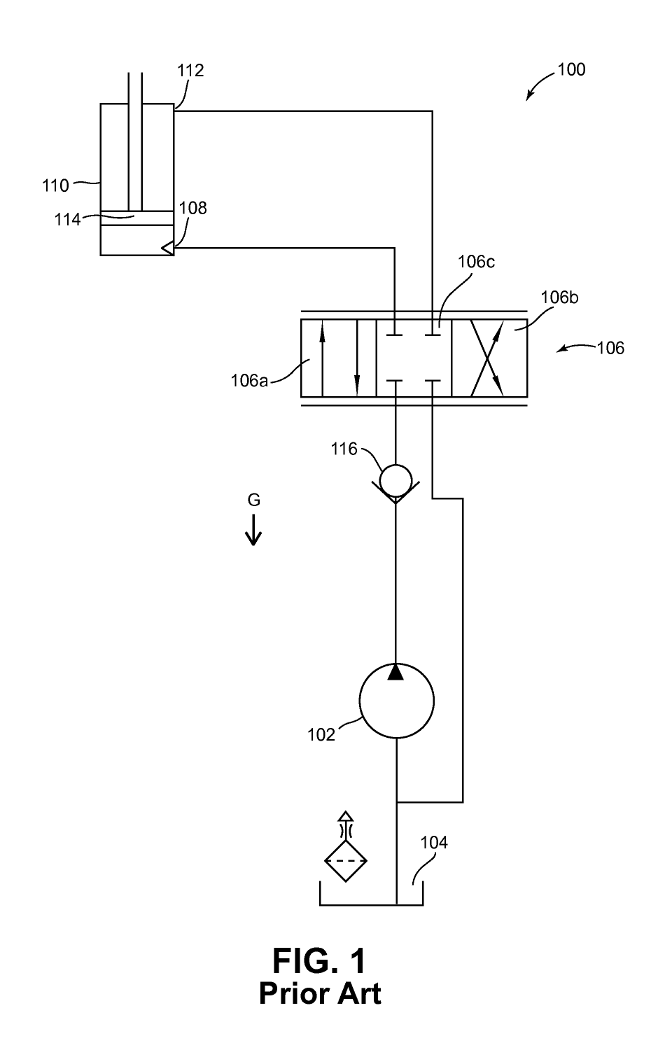

FIG. 2 is a schematic diagram of a hydraulic control system.

FIG. 3 is a control logic diagram for a hydraulic control system.

FIG. 4 depicts a method of controlling a hydraulic system.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

The technology described below has application in systems that utilize hydraulic actuators such as hydraulic cylinders, hydraulic motors, and other types of mechanical devices actuated by hydraulic fluid. Hydraulic actuators are commonly used in industrial equipment and construction equipment (e.g., booms, lifts, swing arms, pivot mechanisms). For clarity, however, the following embodiments will be described in the context of hydraulic cylinders.

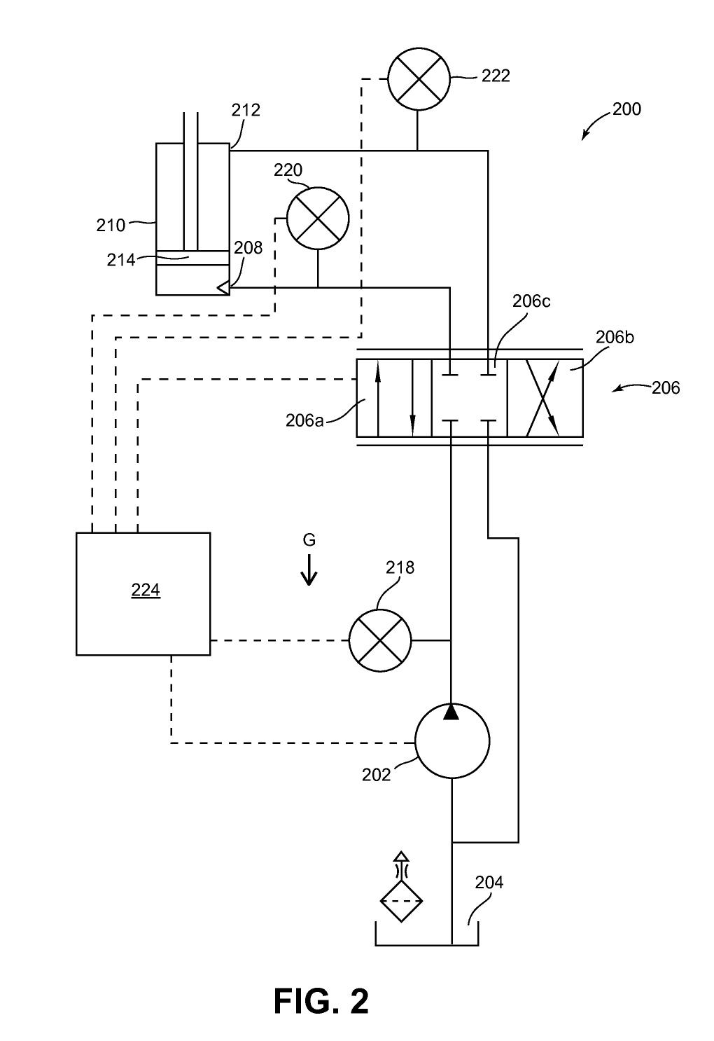

FIG. 2 depicts a schematic of a hydraulic control system 200. The system includes a pump 202, a reservoir 204, and a two-way valve 206. The valve 206, which may be a metering valve, has a first open position 206a, a second open position 206b, and a closed position 206c. The position of the valve 206 controls fluid delivery to either a first port 208 or a second port 212 of a piston cylinder 210, thus moving the piston 214 accordingly. Fluid is also forced from the opposite port 212, 208 back to the reservoir 204, via the valve 206. Instead of a mechanical check valve at the outlet of the pump 202, the control system 200 includes a number of pressure sensors 218, 220, 222 that communicate with a controller 224. The controller 224 is also operatively connected to an actuator (not shown) that actuates the valve 206 between the various positions 206a, 206b, 206c. In certain embodiments, the controller 224 may also control and/or operation of the pump 202.

During operation, the controller 224 continuously monitors signals indicative of the pump supply pressure that are sent from the supply pressure sensor 218. These signals are compared to signals continuously sent from the port pressure sensors 220, 222 that are indicative of the pressure at each port. When the pressure at the port 208 (as sensed by sensor 220) is higher than the supply pressure (as sensed by sensor 218), the controller 224 maintains valve 206 in the closed position 206c, preventing that high fluid pressure from being directed towards the outlet of the pump 202. As the pump 202 increases supply pressure, the controller continues to monitor the signals sent from the sensor 218 and sensor 220. Once the supply pressure is equal to or higher than the port pressure, the valve may open to a first valve position (in this case, to position 206a). As the metering valve 206 opens, pressures from the various sensors are constantly monitored. If the pressure at a port pressure sensor 220, 222 exceeds that of the supply pressure sensor 218, the controller 224 will actuate the valve to the closed position 206c, to prevent the load from falling backwards.

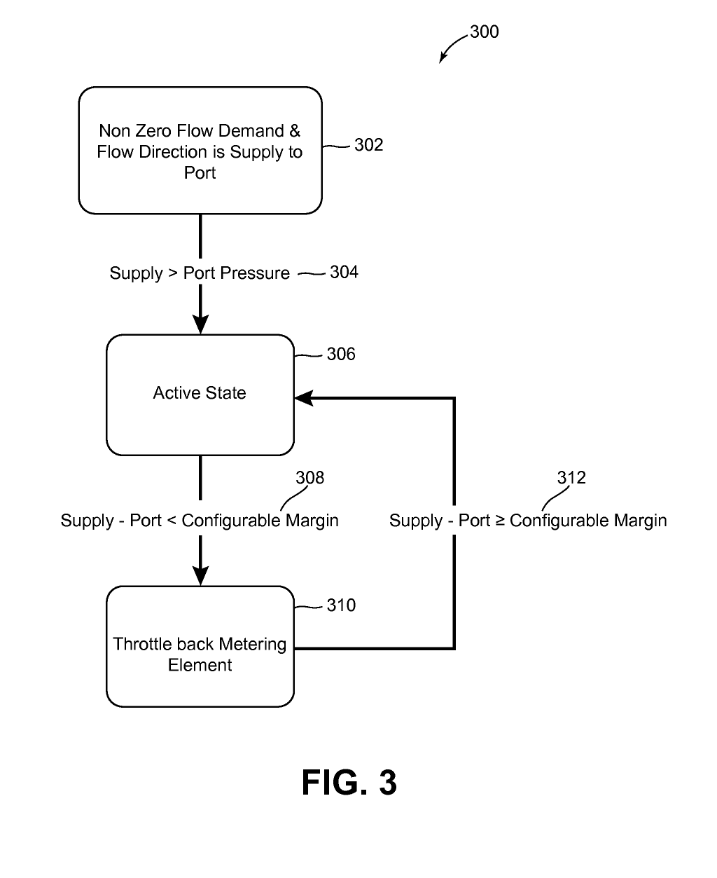

As indicated above, the valve 206 may also be a metering valve. In that case, as the supply pressure and port pressures are monitored, the controller 224 may throttle back the metering valve 206 as the difference (or margin) between the supply pressure and port pressure narrows. That is, as the port pressure increases relative to the supply pressure, the valve 206 will throttle back so as to avoid service/system saturation and to prevent the load from moving in the direction opposite of the command direction. This operation is depicted in FIG. 3, which depicts a control logic diagram 300 for controlling a hydraulic control system, such as the type depicted in FIG. 2. In a first state (302), there is a non-zero flow demand and the flow direction is from the pump outlet (i.e., supply) to one of the cylinder ports. In other words, hydraulic fluid flow by the pump is delivered toward one of the two ports on the cylinder. The port pressure sensors and supply pressure sensor are monitored until the supply pressure is greater than the port pressure (304). More specifically, the supply pressure is compared to the port pressure at the port to which the flow will be directed. If the supply pressure is, in fact, greater than the port pressure, the valve is actuated to an active state (306) and flow through the valve begins as the valve opens. In certain embodiments, the supply pressure may exceed the port pressure by a certain factor, percentage, or other parameter, prior to the valve being actuated to an open position. In certain embodiments, the supply pressure may exceed the first port pressure by about 5 bar prior to the valve being actuated. At higher flow rates greater margins between the supply pressure and port pressure may be desirable.

The pressure sensors are continually monitored when the valve is in the active state. If the difference between the supply pressure and the appropriate port pressure is less than a margin or difference (308), the controller begins throttling back the valve (310) towards a closed position. This margin or difference may be predefined or otherwise configurable. The margin may be configured based on the desired or required performance considerations, operator preferences, or other factors. Throttling back of the valve may continue until the valve closes completely, or until the loads change, such that the difference between the supply pressure and the appropriate port pressure is greater than or equal to the configurable margin (312). In that case, the valve may return to its active state (306) and active sensor monitoring continues.

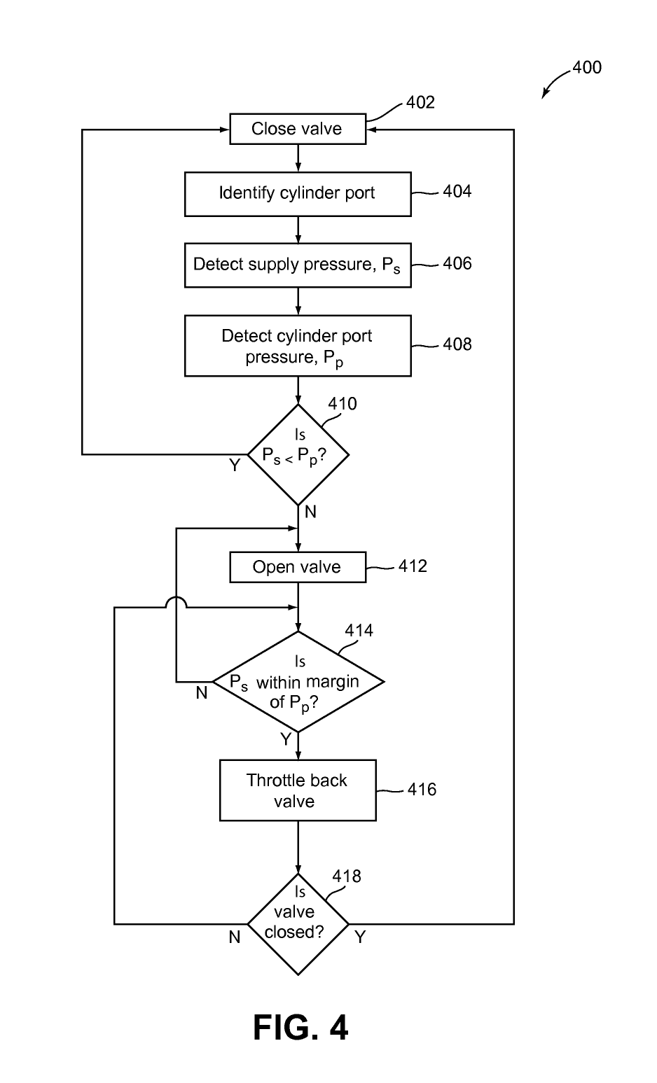

FIG. 4 depicts a method 400 of controlling a hydraulic system. The method 400 begins with a closed metering valve (Step 402), such as the valve depicted in FIG. 2, above. Thereafter, a cylinder port is identified (Step 404), either by an operator-controlled selector switch, or by an electronically-controlled switch. In general, the proposed use of the cylinder will dictate which of the ports is identified. In this case, the identified port will define the port pressure P_{P} to which the supply pressure P_{S} will be compared during the method. The supply pressure P_{S} is detected (Step 406) and a signal indicative of that pressure is sent to the controller. The port pressure P_{P} is then detected (Step 408) and a signal indicative of that pressure is sent to the controller. Thereafter, a comparison of the supply pressure P_{S} and port pressure P_{P} is made (Step 410). If the supply pressure P_{S} is less than the port pressure P_{P}, the valve remains closed (and the control algorithm returns to Step 402). If the supply pressure P_{S} is higher than the port pressure P_{P}, the valve is opened (Step 412). The valve may be either opened completely or metered open, depending on a number of factors that may be programmed into the controller and/or user requirements. In this embodiment, the valve opens completely. Monitoring of the supply pressure P_{S} and port pressure P_{P} continues. If the supply pressure P_{S} is not within a margin of the port pressure P_{P} (Step 414), the valve remains open (i.e., the control algorithm returns to Step 412) and monitoring continues. If the supply pressure P_{S} is determined to be within a margin of the port pressure P_{P}, however, the valve is throttled back (Step 416). If the valve has not throttled back so far as to be closed (Step 418), monitoring of the supply pressure P_{S} and port pressure P_{P}, and comparisons thereof, continue (as in Step 414). As the supply pressure P_{S} differentiates from the port pressure P_{P} by smaller and smaller margins, the valve continues to throttle back (as in Step 416). Once the valve has throttle back such that it is closed or nearly closed (Step 418), the algorithm confirms complete closure of the valve (Step 402) and awaits a new command signal.

Different margins or differences may be programmed into the controller, either at the time of manufacture or in the field by the operator, as required or desired for a particular application. For example, opening of the valve to the first flow position may occur only when a FIRST OPENING MARGIN defined by a first value is reached. For the valve to open into the second flow position, a SECOND OPENING MARGIN, defined by a second value, may be required. Having different opening margins based on the side of the cylinder to which fluid is delivered may be advantageous in applications where safety or other considerations are present. Once the opening margin is reached, the valve may open completely in the active state, or may open to a minimum position. Thereafter, it may be desirable to define a BEGIN THROTTLING MARGIN having a third value that must be reached prior to throttling back of the valve begins. Similarly, STEP THROTTLING MARGINS, defined by a fourth, fifth, or more values, may be associated with different valve positions as the valve is throttled back. Finally, a RE-OPEN MARGIN defined by an additional value may be required prior to the valve re-opening completely. In the above example, each of the margins may be defined by different values. In other embodiments, certain or all of the margins may be defined by the same valve. The margins may be characterized by absolute differences in pressure values, percentage differences, or other appropriate measures.

The electronic sensors described herein are incorporated into a hydraulic control system that does not include a check valve. However, the sensors and controller may also be used in systems that have a mechanical check valve, as a redundant safety system. Additionally, the control system may be used with valves having greater than or fewer than two positions, or in systems with multiple valves. In short, the electronic control system described herein may be used in any hydraulic system where it is desirable to prevent or control backflow. Additionally, the control system described herein may automatically move the valve to a closed position (either actively or by removing power from a spring-close actuator) when signals from one or more of the sensors are not received, or if the signals received may be indicative of an error condition. In other embodiments, signals may be sent to and/or received by the controller at predetermined time intervals, which may be programmed during manufacture or in the field. Additionally, signals may be continuously sent to the controller, but the controller may only use a smaller subset of those signals for the required comparisons between supply pressure and port pressure.

The hydraulic control system described above may be sold as a kit, either in a single package or in multiple packages. A kit may include a controller, pressure sensors, pump, valve, etc. Alternatively, the controller may be sold as a single stand-alone unit. Users may then obtain the various valves, sensors, actuators, etc., separately from a third party or from the pump supplier. If desired, control wiring may be included, although instructions included with the kit may also specify the type of wiring required based on the particular installation.

Additionally, the electronic controller may be loaded with the necessary software or firmware required for use of the system. In alternative configurations, software may be included on various types of storage media (CDs, DVDs, USB drives, etc.) for upload to a standard PC, if the PC is to be used as the controller, or if the PC is used in conjunction with the control or pump system as a user or service interface. Additionally, website addresses and passwords may be included in the kit instructions for programs to be downloaded from a website on the internet.

The control algorithm technology described herein can be realized in hardware, software, or a combination of hardware and software. The technology described herein can be realized in a centralized fashion in one computer system or in a distributed fashion where different elements are spread across several interconnected computer systems. Any kind of computer system or other apparatus adapted for carrying out the methods described herein is suitable. A typical combination of hardware and software can be a general purpose computer system with a computer program that, when being loaded and executed, controls the computer system such that it carries out the methods described herein. Since the technology is also contemplated to be used on heavy construction equipment, however, a stand-alone hardware system including the necessary operator interfaces (cylinder control switch, etc.) may be desirable.

The technology described herein also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A method of controlling a valve, the method comprising:
detecting a supply pressure at a fluid source;
detecting a first port pressure at a first side of a piston, the piston located in a cylinder;
actuating the valve from a closed position to a first open position when the supply pressure is in excess of the first port pressure; and
actuating the valve to the closed position when the supply pressure is less than the first port pressure.

2. The method of claim 1, further comprising:
detecting a second port pressure at a second side of the piston; and
actuating the valve from the closed position to a second open position when the supply pressure is in excess of the second port pressure.

3. The method of claim 1, wherein at least one of the detecting steps occurs at predetermined intervals.

4. The method of claim 1, wherein at least one of the detecting steps is continuous.

5. The method of claim 1, further comprising actuating the valve toward the closed position when a difference between the supply pressure and at least one of the first port pressure and the second port pressure comprises a predetermined parameter.

6. The method of claim 1, further comprising actuating the valve toward the closed position when the supply pressure is about 5 bar greater than the first port pressure.

7. A hydraulic control system comprising:
a piston cylinder;
a pump connected to a source of hydraulic fluid;
a valve located between the piston cylinder and the pump;
a supply pressure sensor located on a fluid line at an outlet of the pump;
a first port pressure sensor located on a fluid line at a first inlet of the piston cylinder; and
a controller operatively connected to the valve, the supply pressure sensor, and the first port pressure sensor,
wherein the controller sends a first signal to actuate the valve from a closed position to a first open position upon detecting a supply pressure higher than a first port pressure, and
wherein the controller actuates the valve to the closed position when the supply pressure is less than the first port pressure.

8. The hydraulic control cylinder of claim 7, further comprising a second port pressure sensor located on a fluid line at a second inlet of the piston cylinder, and wherein the controller sends a second signal to actuate the valve from the closed position to a second open position upon detecting a supply pressure higher than a second port pressure.

9. The hydraulic cylinder of claim 7, wherein the controller detects at least one of the supply pressure and the first port pressure at predetermined intervals.

10. The hydraulic cylinder of claim 7, wherein the controller continuously detects at least one of the supply pressure and the first port pressure.

11. The hydraulic cylinder of claim 7, wherein the controller actuates the valve toward the closed position when a difference between the supply pressure and at least one of the first port pressure and the second port pressure comprises a predetermined parameter.

12. The hydraulic cylinder of claim 7, wherein the controller actuates the valve toward the closed position when the supply pressure is about 5 bar greater than the first port pressure.
